(19) United States
(12) Patent Application Publication
(10) Pub. No.: US 2020/0006887 A1
(43) Pub. Date: Jan. 2, 2020

(54) HIGH-CURRENT CONNECTOR COMPRISING HIGH-CURRENT CONTACT BODIES FOR THREADED ASSEMBLY

(71) Applicant: Amphenol-Tuchel Electronics GmbH, Heilbronn (DE)

(72) Inventors: Dawid Szymura, llsfeld (DE); Hansjürgen Reinwald, Schwaigern (DE)

(21) Appl. No.: 16/490,850

(22) PCT Filed: Mar. 2, 2018
(86) PCT No.: PCT/EP2018/055223

§ 371 Date: Sep. 3, 2019

(30) Foreign Application Priority Data
Mar. 2, 2017 (DE) 10 2017 104 326.8

(51) Int. Cl. H01R 13/53; H01R 4/56; H01R 43/02; H01R 13/52; H01R 13/62; H01R 24/60

(52) U.S. Cl. CPC H01R 13/53; H01R 4/56; H01R 43/0207; H01R 2105/00; H01R 13/62; H01R 24/60; H01R 13/5205

(57) ABSTRACT

The invention relates to a high-current connector comprising at least three high-current contact bodies, the high-current contact bodies each having a high-current contact surface and a high-current cable connection surface for connecting a high-current cable, and the high-current contact bodies each forming a threaded hole for connecting each high-current contact body to a high-current contact mating body of a high-current connector counterpart.

The invention relates to a high current connector for the transmission of high currents.

In the field of the high current technology, currents with current strengths between 300 A and 3000 A must be transmitted, which generates a significant amount of heat, in particular at cable connection points. Heat generation in combination with the transmitted high current strength often leads to cable failure, in particular with cable couplings or cable connectors, involving the risk of a cable fire. In order to make the connecting cable suitable for use with high current, high current cable connectors are designed to be very robust and to have very low transition resistance, for which purposes the typical methods of cable connection technology tend to be insufficient. When cables are coupled by means of screw connections or soldering joints, for instance, the coupling will become undone when subjected to the stress of high current, due to the heat buildup and to electro-erosion. Furthermore, with conventional connecting methods, contact bodies have a high transition resistance between a plug and a socket or between a high current connector and an opposite high current connector side, which increases over time due to aging. Common connectors typically work with springy contact elements, whose spring properties are subject to relaxation due to the currents and the high temperatures caused by them. Due to this relaxation, the springy contact elements do not sufficiently and effectively adjoin the respective opposite contact element, leading to high transition resistance and/or spark formation.

The task of the invention is therefore to overcome the aforementioned disadvantages and to provide a high current connector that is easy to assemble and inexpensive to manufacture. Furthermore, the task of the invention is to generate a connection between the high current contact bodies of a high current connector and the opposite high current contact bodies of an opposite high current connector side that remains secure and constant when exposed to high currents and high temperatures.

This task is solved by the feature combinations in accordance with patent claim 1.

According to the invention, a high current connector is proposed with at least three high current contact bodies. The high current contact bodies respectively feature a high current contact surface and a high current cable connection surface for respectively connecting a high current cable. Furthermore, the respective high current contact bodies each form a threaded hole for connecting the respective high current contact body with a respective opposite high current contact body of a opposite high current connector side. The opposite high current connector side features an opposite high current contact body for each high current contact body. The opposite high current contact body is designed with an eyelet and/or a passage for a connection screw, such that an opposite high current contact surface of the opposite high current contact body can be pressed against the high current contact surface of the high current contact body by the connection screw in order to create an electrically conductive connection between the high current contact body and the opposite high current contact body.

An advantageous further development of the invention provides that the high current contact surface is a front face of the respective high current contact body that is perpendicular to a longitudinal dimension of the respective high current contact body.

Also advantageous is an embodiment in which the respective threaded hole is perpendicular to the respective high current contact surface, intersecting the respective high current contact surface.

In a further advantageous embodiment, the longitudinal axis of the respective threaded hole is centered on the respective high current contact surface. Due to this centering position, the pressure exercised by the connection screw, the threaded hole, and the opposite high current contact surface on the high current contact surface is distributed uniformly, such that the opposite high current contact surface and the high current contact surface have a uniform surface pressure and an optimal mutual contact. By one respective threaded hole per high current contact body, the surface pressure and the optimal contact between the respective contact bodies and the opposite high current contact body respective can be formed.

In an additional advantageous further development, the high current contact bodies respectively form at least one auxiliary high current contact surface that are arranged perpendicular to the respective high current contact surface. The auxiliary high current contact surfaces serve for aligning the respective opposite high current contact body with the high current contact body, and they also enlarge the effective contact surface between the opposite high current contact body and the high current contact body. In order to increase the contact surface, the opposite high current contact body surrounds the high current contact body at least until an auxiliary high current contact surface.

In one advantageous embodiment, the respective high current contact bodies are at least in part surrounded by an insulating body that is substantially located inside the high current connector. The insulating body insulates the at least three high current contact bodies from one another, such that the high current contact bodies cannot be in contact with each other. The insulating body preferably consists of two pieces, with an upper surface and a lower surface, sealing the interior space in the interior of the insulating body from its surroundings. The insulation of the contact bodies from one another is realized by means of separating or positioning ridges in the interior, or by a foam that fills the interior space. The separating or positioning ridges are formed by the insulating body.

In an additional advantageous further development, the high current contact bodies feature a circumferential recess respectively extending in the radial direction, respectively engaged by the insulating body in order to fixate the high current contact body with respect to the insulating body, thereby creating a seal. The sealing effect can be improved by means of additional recesses and/or additional sealing elements or sealing structures, such as a labyrinth seal, for instance. The high current contact bodies protrude from the insulating body at least partially with their respective at least one auxiliary high current contact surface in the direction of their longitudinal axis. Furthermore, the auxiliary high current contact surfaces are formed, respectively departing from the recess, in the direction of the respective high current contact surface.

In an additional advantageous embodiment, the high current connector features a shield contact body. The shield contact body substantially surrounds the high current contact bodies in the longitudinal dimension of the high current contact body in their entirety, such that the high current contact bodies protrude with their high current contact surface and at least with part of the auxiliary high current contact surface from the shield contact body. The shield contact body has at least one shield contact surface for contacting an opposite shield contact surface of the opposite high current connector side, as well as a shield connection point for connecting a shield for the high current cables. Preferably, a joint shield of the high current cables can be connected to the shield connection point.

In an advantageous embodiment, the shield contact body surrounds the insulating body in a radial direction and supports the insulating body by means of a plurality of protrusions, such that the insulating body has a fixed position relative to the shield contact body. Furthermore, there is a substantially sealed transition between a first section of the shield contact body, in which the cable ducts and the cable strain reliefs are formed, and the insulating body.

In an advantageous further development, at least one sealing element is arranged between the high current cable and the shield contact body on the shield contact body at a respective cable duct through which the high current cable is guided into the shield contact body, in other words, the shield contact body features at least one sealing element. The sealing element is arranged such that an interior space of the shield body, in particular in the first section, which transitions into an interior space of the insulating body, is sealed, and in that between the at least one sealing element and the recesses of the high current contact body engaged by the insulating body in such a manner as to seal it, an interior space is generated that is sealed relative to the surroundings. By sealing the section of the shield contact body and of the interior space of the insulating body, the high current cable connection surface are protected against humidity and against possible corrosion.

Furthermore, in an advantageous further development, the shield contact body forms a circulating groove geometry into which a shield plate is molded, such that the shield plate surrounds at least a portion of the shield contact body in a radial direction. The shield plate is preferably made out of an electrically conductive material, and is electroconductively contacted by the cable shield or by multiple cable shields. The shield plate integrally supports the cable against the shield contact body, and has a sealing function.

In an advantageous embodiment, the high current contact body is substantially cuboid. In the high current contact body, the high current cable connection surface is formed by a groove-shaped recess, which extends from the rear surface, formed by the surface facing away from the high current contact surface, in the direction of the high current contact surface, and whose form corresponds with the form of the high current cable attached to it for fastening purposes.

Furthermore, an additional advantageous further development provides that the high current cable is welded with its high current cable connection surface to the high current contact body. Preferably, the high current cable is welded to the high current contact body by means of ultrasonic welding.

Advantageously, in a further development, the threaded holes are formed as blind holes with inner threading formed, thus sealing the interior space and preventing humidity or liquids, dust, and air from penetrating the interior space within the insulating body by way of the high current contact bodies.

A further advantageous embodiment of the high current connector provides for the high current connector to have current load rating between 300 A and 3000 A, and/or a thermal stability range from 125° C. to 250° C.

The features disclosed above can be combined arbitrarily, to the extent that this is technically feasible, and to the extent that they are not mutually conflicting.

Other advantageous further developments of the invention are described in the subsidiary claims, or will be described in further detail below, together with the description of the preferred embodiment of the invention, based on the figures. The figures show as follows:

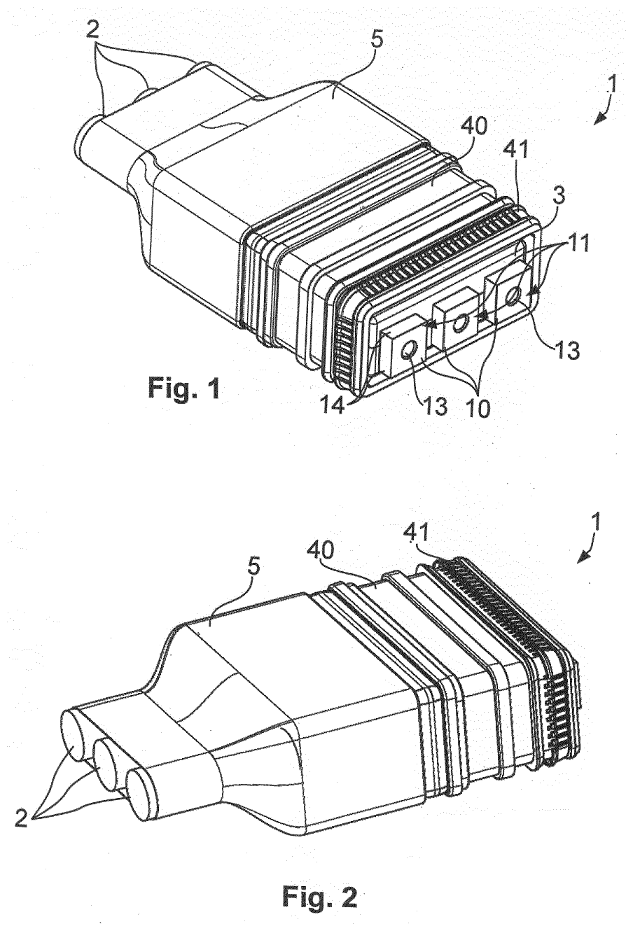

FIG. 1 a spatial representation of a high current connector;

FIG. 2 a rotated spatial representation of a high current connector;

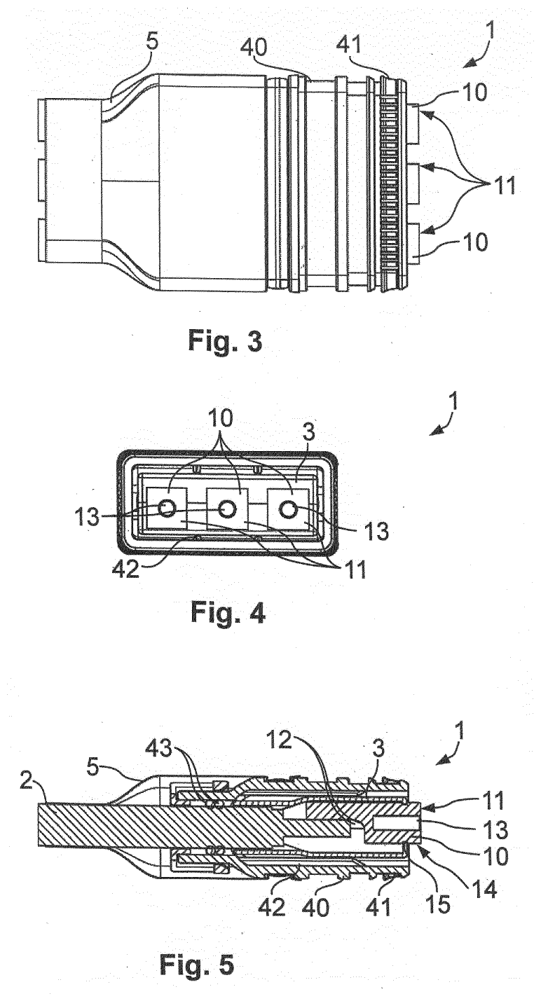

FIG. 3 a top view of a high current connector;

FIG. 4 a frontal view of a high current connector;

FIG. 5 a sectional view of a high current connector.

The figures are exemplarily schematic. Identical reference numbers in the figures refer to identical functional and/or structural features.

FIG. 1 shows an isometric spatial representation of a high current connector 1, wherein the three high current contact surfaces 11 of the high current contact body 10 protrude from the shield contact body 40. The auxiliary high current contact surfaces 14 extend from the two-piece insulating body 3 to the high current contact surfaces 11. Centered on each of the high current contact surfaces 11 is respective threaded hole 13, into which a respective screw can be screwed. The insulating body 3 is surrounded in its radial direction in its entirety by the shield contact body 40, wherein the shield contact body 40 features a circumferential shield contact surface 41 at its high current contact surface end. At the end facing away from the high current contact surface, a shield plate 5 is arranged on the shield contact body 40, and pressed into a groove of the shield contact body 40. The shield plate 5 extends until the high current cables 2, which it surrounds at least in part.

FIG. 2 shows a high current connector 1 as in FIG. 1 in a rotated view, such that the high current contact surfaces 11 cannot be seen.

FIG. 3 shows a top view of a high current connector 1 as shown in FIGS. 1 and 2. It shows that the high current contact bodies 10 are aligned identically, such that the high current contact surfaces 11 are arranged in the same plane.

FIG. 4, which shows a high current connector 1 as shown in FIGS. 1 through 3, clearly shows a dividing plane of the insulating body 3, dividing the insulating body 3 into an upper surface and a lower surface. Furthermore, the protrusions 42 are shown, by means of which the insulating body 3 is supported in the shield contact body 40. Through the support by the protrusions 42, the upper and lower surfaces of the insulating body 3 are pressed against each other, thus strengthening the sealing and fixating effect of the insulating body 3.

FIG. 5 shows a cross-section of a high current connector 1 along a longitudinal axis of the high current connector 1, in which a high current contact body 10 is shown, divided through the middle. The sectional view shows in particular the form of the high current contact body 10, with the radially circumferential recess 15 of the high current contact body 10. Furthermore, it shows that the insulating body 3 engages the recess 15, thus sealing the interior space of the insulating body 3 and fixing the high current contact bodies 10. The high current cable 2 is guided through a section of the shield body and fixated and relieved by means of a cable strain reliefs. After the relief of the cable strain, a respective cable is sealed with respect to the shield contact body 40 by two sealing elements 43 embodied as ring seals, such that the section of the shield contact body 40 and the interior space of the insulating body 3 are sealed with respect to the surroundings, and dust particles and humidity are substantially prevented from penetrating.

The invention is not limited to the aforementioned specified preferred exemplary embodiments. Rather, a number of variants is conceivable that implement the presented solution, even in substantially different embodiments. A high current contact surface might feature multiple threaded holes, for instance, or external threading.

### REFERENCE LIST

1 High current connector
2 High current cable
3 Insulating body
5 Shield plate
10 High current contact body
11 High current contact surface
12 High current cable connection surface
13 Threaded hole
14 Auxiliary high current contact surface
15 Recess
40 Shield contact body
41 Shield contact surface
42 Protrusion
43 Sealing element

1. A high current connector with at least three high current contact bodies, wherein the high current contact bodies respectively have a high current contact surface and a high current cable connection surface for respectively connecting a high current cable, and wherein the high current contact bodies respectively form a threaded hole for connecting the respective high current contact body with a respective opposite high current contact body of an opposite high current connector side.

2. The high current connector according to claim 1, wherein the high current contact surface is a front face of the respective high current contact body that is arranged perpendicular to a longitudinal dimension of the respective high current contact body.

3. The high current connector according to claim 1, wherein the respective threaded hole is perpendicular to the respective high current contact surface and intersects the respective high current contact surface.

4. The high current connector according to claim 1, wherein the position of the longitudinal axis of the respective threaded hole is centered on the respective high current contact surface.

5. The high current connector according to claim 1, wherein the high current contact bodies respectively form at least one auxiliary high current contact surface that is perpendicular to the respective high current contact surface.

6. The high current connector according to claim 1, wherein the high current contact bodies are respectively surrounded at least in part by an insulating body that is substantially positioned within the high current connector, wherein the insulating body insulates the at least three high current contact bodies from one another.

7. The high current connector according to claim 5, wherein the high current contact bodies respectively feature a circumferential recess extending in the radial direction, respectively engaged by the insulating body in order to fixate the high current contact body with respect to the insulating body, thereby creating a seal, wherein the high current contact bodies protrude from the insulating body at least partially with their respective at least one auxiliary high current contact surface in the direction of their longitudinal axis, and wherein the auxiliary high current contact surfaces are formed, respectively departing from the recess, in the direction of the respective high current contact surface.

8. The high current connector according to claim 1, wherein the high current connector has a shield contact body, which surrounds the high current contact bodies in its longitudinal dimension substantially in their entirety and which has at least one shield contact surface for contacting an opposite shield contact surface of the opposite high current connector side, as well as a shield connection point for connecting a shield, preferably a joint shield, of the high current cables.

9. The high current connector according to claim 8, wherein the shield contact body surrounds the insulating body in a radial direction and supports the insulating body by means of a plurality of protrusions.

10. The high current connector according to claim 8, wherein at a respective cable duct through which the high current cable is guided into the shield contact body, the shield contact body features at least one sealing element between the high current cable and the shield contact body, such that an interior space of the shield contact body, which transitions into an interior space of the insulating body, is sealed with respect to its surroundings between the at least one sealing element and the recesses of the high current contact body that are engaged by the insulating body so as to form a seal.

11. The high current connector according to claim 8, wherein the shield contact body forms a circulating groove geometry, molded into which is a shield plate such that the shield plate surrounds at least a portion of the shield contact body in a radial direction.

12. The high current connector according to claim 1, wherein the high current contact body is substantially cuboid.

13. The high current connector according to claim 1, wherein the high current cable is welded onto the high current cable connection surface with the high current contact body preferably by means of ultrasonic welding.

14. The high current connector according to claim 1, wherein the threaded hole is a blind hole.

15. The high current connector according to claim 1, wherein the high current connector has a current load rating between 300 A and 3000 A, and/or the high current connector has a thermal stability range from 125° C. to 250° C.
